(19) United States
(12) Patent Application Publication
(10) Pub. No.: US 2010/0065983 A1
(43) Pub. Date: Mar. 18, 2010

(54) METHOD OF COMPRESSION-MOLDING LIGHT-EMITTING ELEMENTS

(75) Inventor: Kazuki Kawakubo, Otsu-shi (JP)

Correspondence Address: OLIFF & BERRIDGE, PLC, P.O. BOX 320850, ALEXANDRIA, VA, 22320-4850, US

(73) Assignee: TOWA CORPORATION, Kyoto-shi, Kyoto (JP)

(21) Appl. No.: 12/438,155

(22) PCT Filed: Feb. 13, 2008
(86) PCT No.: PCT/JP2008/000215

§ 371 Date: Feb. 20, 2009

(30) Foreign Application Priority Data
Feb. 27, 2007 (JP) 2007-046348

(51) Int. Cl. B29C 43/18

(52) U.S. Cl. 264/272.14

(57) ABSTRACT

A method of compression-molding light emitting elements is provided, which can efficiently prevent the formation of a resin burr on a frame on which LED chips (light-emitting elements) are mounted. A tape for resin burr prevention is adhered to a surface of the frame, i.e. the surface on which no light-emitting element is mounted, to form a tape-applied frame. The tape-applied frame is supplied and set onto a setting section of an upper die, with the LED chips directed downwards. A required amount of transparent liquid resin material is dripped by a dispenser into a large cavity including small cavities. Then, both the upper and lower dies are clamped with a required clamping pressure, whereby the LED chips are individually immersed in the resin contained in the small cavities inside the large cavity and compression-molded to form a molded frame (light emitters).

### TECHNICAL FIELD

The present invention relates to a method of compression-molding light-emitting elements, in which light-emitting diode (LED) chips or similar light-emitting elements mounted on a frame are compression-molded with a transparent resin material to form a light emitter (product).

### BACKGROUND ART

Light emitters using LED chips or similar light-emitting elements have been manufactured and used for years. For example, a type of generally used light emitter is manufactured as follows.

As shown in FIG. 7(1), a light-emitting device body 82 having a cavity 83 with a trapezoid sectional shape is mounted on a frame 81. After an LED chip 84 is set in the cavity 83, a transparent liquid resin material 86 is dripped from a dispenser 85 into the cavity 83 to form a light-emitting device 87 (light-emitting part). Subsequently, a pre-molded lens member 89 (which is a convex lens in the illustrated example) is bonded onto the emission surface 88 of the light-emitting device 87 to complete a light emitter 90 (product).

The example shown in FIG. 7(1) sequentially illustrates each of these manufacturing processes in the right-to-left direction on the figure.

Formation of the frame 81 on which the light emitter (product) 90 shown in FIG. 7(1) is mounted requires the following three production processes: filling the resin material of the light-emitting device, pre-molding the lens member, and bonding the lens member. The presence of these processes prevents efficient improvement in the manufacturing efficiency of the product (light emitter).

Given this problem, efforts have been made to simplify the three processes. One such effort is directed at modifying the structure of the light emitter from the viewpoint of efficiently improving the manufacturing efficiency of the product so as to provide a single production process which can greatly improve the manufacturing efficiency of the product (light emitter).

For example, LED light emitters 65 and 73 (molded frames 61 and 71) with the structures shown in FIGS. 6(1) and 6(2) have been proposed as the LED light emitters that are designed to simplify the aforementioned three processes and efficiently improve the manufacturing efficiency of the product.

Patent Document 1: Japanese Unexamined Patent Application Publication No. 2003-80537

### DISCLOSURE OF THE INVENTION

### Problem to be Solved by the Invention

The light emitters 65 and 73 (or molded frames 61 and 71) shown in FIGS. 6(1) and 6(2) can be formed by the single production process of directly compression-molding (or resin-encapsulating) the LED chip 4 mounted on the frame 5 (i.e. an ante-molding frame 6) into a light-emitting part 64 or 72 having a required shape.

However, as shown in FIG. 7(2) which corresponds to the molded frame 61 shown in FIG. 6(1), this method has the problem that the resin (10) can easily leak to the back surface of the frame 5 (i.e. the surface on which no the light-emitting element is mounted; this surface is hereinafter called the “element-free surface 5a”) and harden, fanning a resin burr (or cured resin) 91 on the back surface 5a of the same frame.

For example, in the case of compression-molding an LED chip 4 mounted on a frame 5 (e.g. a metal frame or lead frame) having a specified pattern consisting of punch-out portions (through bores) created by punching work, the resin can easily leak through the punch-out portions (through-hole portions) to the back surface (element-free surface 5a) and harden, forming a resin burr 91 adhered to the back surface 5a of the same frame.

The formation of the resin burr 91 deteriorates the yield of the product and prevents efficient improvements in the manufacturing efficiency of the product.

In the case of compression-molding an LED chip 4 mounted on a flat frame 5 (e.g. a substrate with no punch-out portions), the resin (10) can easily leak beyond the side edge (or lateral side) of the frame 5 to the back surface (element-free surface 5a). The leaked resin (10) will harden and eventually form a resin burr 91 on the back surface 5a of the frame.

Therefore, as in the case of the previous frame 5 having punch-out portions, the yield of the product will deteriorate, so that the manufacturing efficiency of the product cannot be efficiently improved.

Thus, one objective of the present invention is to provide a method of compression-molding light-emitting elements which can efficiently prevent the formation of a resin burr 91 on a frame 5 on which light-emitting elements (e.g. LED chips 4) are mounted.

Another objective of the present invention is to provide a method of compression-molding light-emitting elements which can efficiently improve the manufacturing efficiency of the product (the light emitter 65 or 73).

### Means for Solving the Problems

The present invention aimed at solving the previously described technical problems provides a method of compression-molding light-emitting elements, using a molding die for compression-molding light-emitting elements, the molding die including at least upper and lower dies. This method is characterized by the following processes: supplying and setting a frame, with a required number of light-emitting elements mounted thereon, onto a frame-setting section provided in the upper die of the molding die; supplying a required amount of resin material into each of individual cavities formed in the lower die of the molding die, the individual cavities respectively corresponding to the required number of light-emitting elements mounted on the frame; and compression-molding a light emitter within each individual cavity by clamping the dies of the molding die in such a manner that the light-emitting elements are respectively immersed into the resin contained in the individual cavities, wherein the compression-molding process is performed with a resin sheet for resin burr prevention sandwiched between the upper die and the surface of the frame on which no light-emitting element is mounted.

In one mode of the present invention aimed at solving the previously described technical problems, the method of compression-molding light-emitting elements is further characterized by: creating a molded frame by performing the compression-molding process with the resin sheet for resin burr prevention sandwiched between the upper die and the surface of the frame on which no light-emitting element is mounted; and cutting the molded frame at a specific position to form an individual light emitter.

In another mode of the present invention aimed at solving the previously described technical problems, the method of compression-molding light-emitting elements is further characterized in that the resin supplied into the individual cavities is uniformly distributed through a connection channel interconnecting the individual cavities.

In another mode of the present invention aimed at solving the previously described technical problems, the method of compression-molding light-emitting elements is further characterized in that the compression-molding process is performed with a mold release film covering the inside of the individual cavities.

In another mode of the present invention aimed at solving the previously described technical problems, the method of compression-molding light-emitting elements is further characterized in that the compression-molding of the light-emitting elements being immersed in the individual cavities is performed while an outside-air shut-off region, which includes at least the inside of the individual cavities, is set at a predetermined degree of vacuum.

An example of the resin sheet is a tape applied on the surface on which no light-emitting element is mounted. Another example is a release film conventionally used for mold-releasing purposes.

### EFFECTS OF THE INVENTION

The present invention has the beneficial effect of providing a method of compression-molding light-emitting elements which can efficiently prevent the formation of a resin burr on a frame on which light-emitting elements (e.g. LED chips) are mounted.

The present invention also has the beneficial effect of providing a method of compression-molding light-emitting elements which can efficiently improve the manufacturing efficiency of the product (light emitter).

### BRIEF DESCRIPTION OF THE DRAWINGS

FIG. 1 is a schematic vertical sectional view illustrating a method of compression-molding light-emitting elements according to the present invention, the view schematically showing a molding die for compression-molding light-emitting elements, with the dies in the open state before a molding operation.

FIG. 2 is a schematic vertical sectional view showing the same molding die as the one shown in FIG. 1, with the dies in the closed state.

FIG. 3 is a schematic vertical sectional view showing the same molding die as the one shown in FIG. 1, with the dies in the open state after the molding operation.

FIG. 4 is a schematic vertical sectional view illustrating another method of compression-molding light-emitting elements according to the present invention, the view schematically showing a molding die for compression-molding light-emitting elements, with dies in the open state before a molding operation.

FIG. 5 is a schematic vertical sectional view showing the same molding die as the one shown in FIG. 4, with the dies in the closed state.

FIGS. 6(1) and 6(2) are schematic vertical sectional views each schematically showing a molded frame (light emitter) used in the method of compression-molding light-emitting elements according to the present invention.

FIGS. 7(1) and 7(2) are schematic vertical sectional views each schematically showing a molded frame (light emitter) used in a conventional method of compression-molding light-emitting elements.

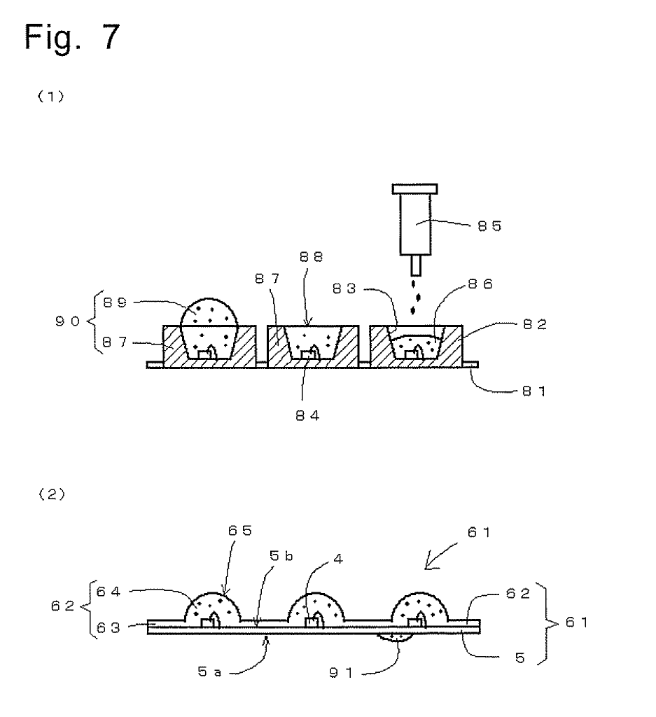

FIG. 8 is a schematic vertical sectional view showing a molding die for compression-molding used in the third embodiment.

### EXPLANATION OF NUMERALS

1 . . . Molding Die for Compression-Molding Light-Emitting Elements
2 . . . Fixed Upper Die
3 . . . Movable Lower Die
4 . . . LED Chip (Light-Emitting Element)
5 . . . Frame
5a . . . Element-Free Surface of the Frame
5b . . . Element-Mounted Surface of the Frame
6 . . . Ante-Molding Frame
7 . . . Frame-Setting Section
8 . . . Large Cavity (Connection Channel)
9 . . . Small Cavity (Individual Cavity)
10 . . . Liquid Resin Material
11 . . . Vertical Dispenser (Resin Material Supply Mechanism)
12 . . . Resin Burr Prevention Tape
13 . . . Tape-Applied Frame
21 . . . Molding Die for Compression-Molding Light-Emitting Element
22 . . . Upper Die
23 . . . Lower Die
24 . . . Central Die (Intermediate Plate)
25 . . . Frame-Setting Section
26 . . . Mold Release Film
27 . . . Individual Cavity
28 . . . Outside-Air Shut-Off Member
29 . . . Liquid Resin Material
30 . . . Horizontal Dispenser (Resin Material Supply Mechanism)
41 . . . Release Film
61 . . . Molded frame
62 . . . Collective Resin-Molded Light-Emitting Body
63 . . . Base Part
64 . . . Light-Emitting Part (Lens Part)
65 . . . Light Emitter
66 . . . Tape-Applied Frame After Compression-Molding
71 . . . Molded frame
72 . . . Individual Resin-Molded Light-Emitting Body (Light-Emitting Part)
73 . . . Light Emitter
74 . . . Tape-Applied Frame After Compression-Molding

### BEST MODE FOR CARRYING OUT THE INVENTION

In the best mode of the present invention, a molding die for compression-molding light-emitting elements that includes at least upper and lower dies (or at least two dies) is used. LED chips (light-emitting elements) are mounted on one surface of a frame. A tape for resin burr prevention is applied to the other surface of the frame on which no light-emitting element is mounted. The tape-applied frame thus formed is supplied and set onto a setting section of the upper die (i.e. the die located in the upper portion of the molding die), with the LED chips directed downwards.

Then, a required amount of transparent liquid resin material is supplied by a dispenser into a required number of individual cavities (which may in some cases include a large cavity that functions as a channel for the resin) formed in the lower die (i.e. the die located in the lower portion of the molding die), the cavities respectively corresponding to the required number of LED chips mounted on the frame.

Subsequently, the upper and lower dies are clamped together by a required clamping pressure (with the molding surfaces of the two dies facing each other). Thus, the LED chips can be respectively immersed into the resin contained in the individual cavities and compression-molded.

After a period of time required for the resin to harden has elapsed, the upper and lower dies are opened to obtain the LED chips compression-molded in a transparent resin-molded light-emitting body (light-emitting part) whose shape corresponds to that of the individual cavities.

After the compression-molding is completed, the tape is peeled off from the tape-applied frame to obtain a molded frame.

As described previously, the compression-molding of LED chips (light-emitting elements) mounted on the frame is performed with a tape applied to the element-free surface of the frame. The tape thus applied efficiently prevents the resin from penetrating through a punch-out portion of the frame to the element-free surface and forming a burr.

Performing the compression-molding process with the tape applied to the element-free surface of the frame as described earlier also efficiently prevents the resin from flowing around the side edge of the frame to the element-free surface thereof and forming a burr on the frame.

As a result, the yield of the product (light emitter) is efficiently improved, so that the manufacturing efficiency of the product is also efficiently improved.

### First Embodiment

The first embodiment of the present invention is hereinafter detailed on the basis of the drawings illustrating the embodiment.

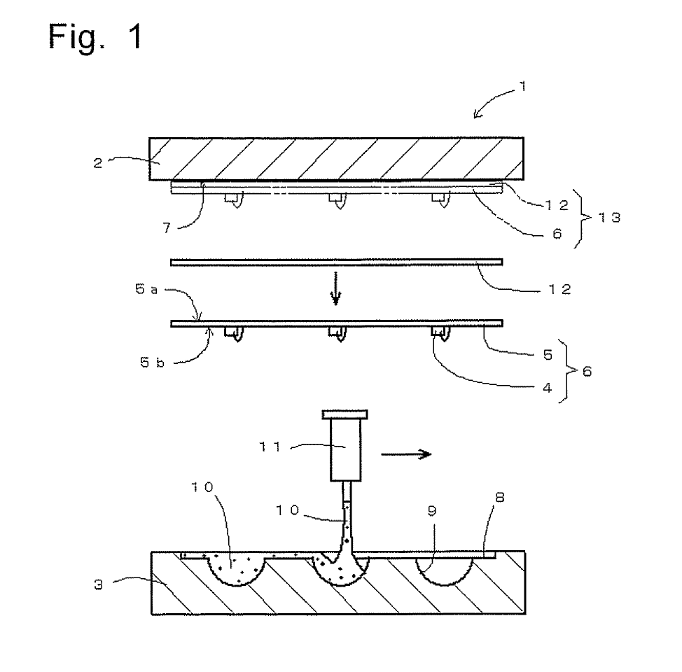

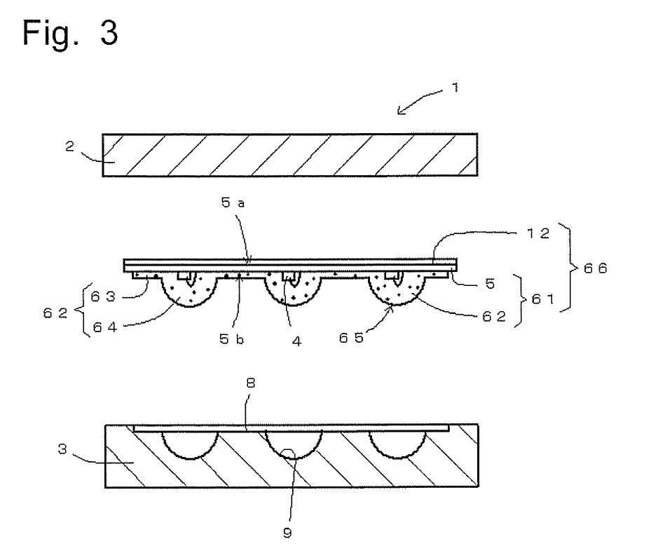

FIGS. 1, 2 and 3 show a molding die for compression-molding light-emitting elements according to the first embodiment.

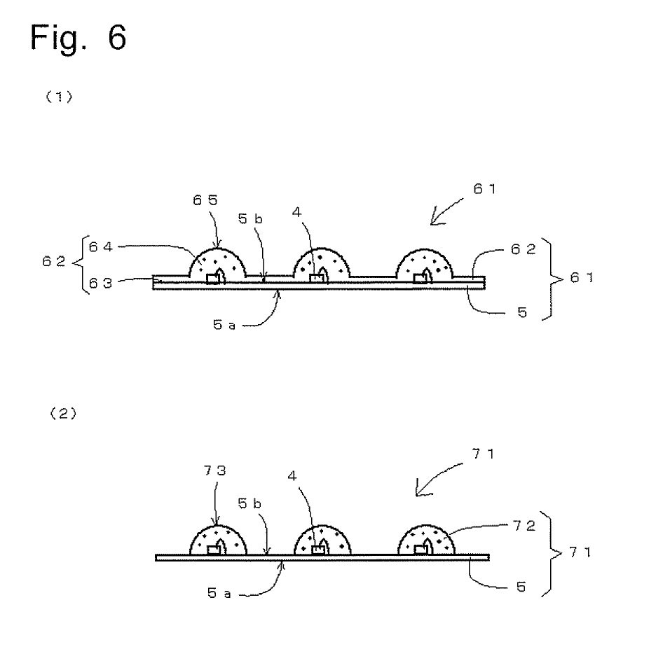

The molded frame (light emitter) shown in FIG. 6(1) has been compression-molded with the molding die shown in FIGS. 1, 2 and 3.

### (Details of Molded Frame)

The molded frame 61 shown in FIG. 6(1) consists of a frame 5 and a collective resin-molded light-emitting body 62 with transparency (optical permeability). The collective resin-molded light-emitting body 62 consists of a base part 63 formed on the frame 5 and a required number of light-emitting parts (lens parts) 64.

Each of the light-emitting parts 64 is created by compression-molding (resin encapsulation) an LED chip 4 mounted on the frame 5. The molded frame 61 (with a required number of LED chips 4) can function as a surface emission light source.

It is also possible to cut this molded frame 61 at specific positions to form light emitters 65 (products), each including the light-emitting part 64 as the main component and a fragment of the base part 63 with the ante-molding frame 6. Each light emitter 65 (or LED chip 4) can function as an independent light source.

### (Molding Die for Compression-Molding Light-Emitting Elements)

The molding die for compression-molding light-emitting elements shown in FIGS. 1, 2 and 3 includes a fixed upper die 2 and a movable lower die 3 facing the upper die 2. In the molding surface of this upper die 2, a frame-setting section 7 is formed, on which the frame 5 (ante-molding frame 6) with a required number of LED chips 4 (light-emitting elements) mounted thereon can be supplied and set with metal clips or other fixtures (not shown), with the LED chips 4 directed toward the lower die 3 (i.e. downwards).

Formed in the molding surface of the lower die 3 is a large cavity 8 (“collective cavity”), which is designed to receive all of the required number of LED chips 4 (i.e. the approximately entire surface of the frame). The large cavity 8 also has a required number (three in the illustrated example) of small cavities 9 (individual cavities) formed in its bottom surface. These cavities respectively correspond to the LED chips 4.

The depth of the large cavity 8 and that of the small cavities 9 are appropriately determined. In the illustrated example, the depth of the large cavity 8 is approximately equal to the thickness of the frame 5.

Although not shown, the molding die 1 (the upper and lower dies 2 and 3) is provided with a heating means for heating the molding die 1 to a required temperature and a clamping means for clamping the molding die 1 by a required clamping pressure.

After the frame 5 with the LED chips 4 mounted thereon is supplied and set onto the setting section 7 of the upper die 2, when the molding die 1 is closed, the LED chips 4 will be individually set into the small cavities 9 inside the large cavity 8.

Also provided for the molding die 1 is a vertical dispenser 11 (resin material supply mechanism) for dripping a required amount of transparent liquid resin material 10 into the large cavity 8 including the required number of small cavities 9.

When the required amount of transparent liquid resin material 10 is supplied by this dispenser 11 into the large cavity 8 including the small cavities 9 formed in the lower die 2, the liquid resin material 10 will fill each of the small cavities 9 as well as the large cavity 8.

When the molding die 1 is closed, the LED chips 4 are individually immersed into the resin 10 contained in the small cavities 9 inside the large cavity 8. Thus, the LED chips 4 can be individually compression-molded in each small cavity 9 including the large cavity 8.

Thus, the molded frame 61 is completed, with the LED chips 4 individually resin-encapsulated in the collective resin-molded light-emitting body 62 whose shape corresponds to that of the large cavity 8 including the small cavities 9.

As explained earlier, the collective resin-molded light-emitting body 62 in the molded frame 61 consists of the light-emitting parts 64 corresponding to the small cavities 9 and the base part 63 corresponding to the large cavity 8.

When the heating means is energized, the heat thereby generated gradually increases the viscosity of the transparent liquid resin material 10 supplied in the cavities 8 and 9, causing the liquid to harden (or solidify).

### (Details of Tape-Applied Frame)

As will be described later, a tape 12 for resin burr prevention can be applied to the element-free surface 5a of the frame 5 (e.g. over the entire element-free surface 5a) to form a tape-applied frame 13. The resin burr prevention tape 12 efficiently prevents the resin 10 from leaking from the non-tape-applied surface (element-mounted surface) 5b to the tape-applied surface (element-free surface) 5a. Thus, the resin is efficiently prevented from forming a burr on the element-free surface 5a of the frame 5.

Examples of the frame 5 include circuit boards, resin plates, metal frames and lead frames.

In the first embodiment, the frame 5 with the LED chips 4 mounted thereon may be either a frame having a required pattern consisting of punch-out portions (through bores) created by punching work or a flat plate (with no punch-out portions).

In the former case, the tape 12 efficiently prevents the resin 10 from leaking from the non-tape-applied surface 5b (element-mounted surface) of the frame 5 to the element-free surface 5a through the punch-out portions (through-hole portions) and forming a burr on the element-free surface 5a.

In the latter case, the tape 12 efficiently prevents the resin from flowing around the side edge of the frame 5 and forming a burr on the element-free surface 5a.

In any of these cases, the use of the tape 12 efficiently improves the yield of the product (light emitter 65 or 73), so that the manufacturing efficiency of the product is also efficiently improved.

### (Method of Compression-Molding Light-Emitting Elements)

Firstly, as shown in FIG. 1, a tape 12 for resin burr prevention is applied to the element-free surface 5a of the frame 5, on which LED chips (light-emitting elements) 4 are mounted, to form a tape-applied frame 13. This tape-applied frame 13 is then supplied and set onto the setting section 7 of the upper die 2, with the LED chips 4 directed downwards. At this point, the LED chips 4 are on the side of the frame 5 facing the lower die cavities 8 and 9, whereas the tape 12 applied to the frame 5 is on the side facing the upper die 2.

Next, a required amount of transparent liquid resin material 10 is dripped by the vertical dispenser 11 into the large cavity 8.

The resin material 10 thus supplied will uniformly spread over the large cavity 8 including the small cavities 9.

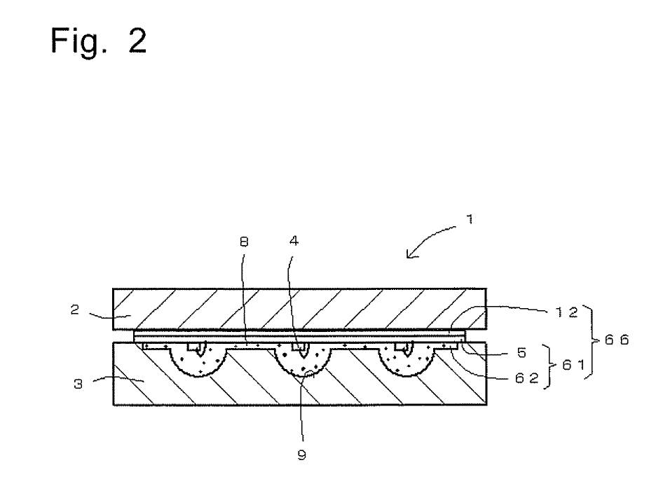

Next, as shown in FIG. 2, the upper and lower dies 1 (2 and 3) are clamped together by a required clamping pressure. As a result, the LED chips 4 will be individually immersed in the resin 10 contained in the small cavity 9 including the large cavity 8 and compression-molded.

In this process, the LED chips 4 are individually set into the small cavities 9.

In the same process, the large cavity 8 functions as a connection channel for the resin material 10 and efficiently prevents shortage of the resin material 10 in any of the cavities 9. Thus, the resin material 10 is uniformly distributed.

The clamping pressure applies a required resin pressure to the inside of the large cavity 8 including the small cavities 9.

After a period of time required for the resin to harden has elapsed, the upper and lower dies 1 (2 and 3) are opened to obtain a required number of LED chips 4 compression-molded in the collective resin-molded light-emitting body 62 with transparency whose shape corresponds to that of the large cavity 8 including the required number of small cavities 9. Thus, a compression-molded tape-applied frame 66 is obtained.

Finally, the tape 12 is peeled off from the element-free surface 5a of the compression-molded tape-applied frame 66 to obtain a molded frame 61.

As shown in FIG. 6(1), the molded frame 61 has the collective resin-molded light-emitting body 62 on the element-free surface 5b of the frame 5. This body 62 consists of the base part 63 whose shape corresponds to that of the large cavity (connection channel) 8 and the light-emitting parts 64 whose shape corresponds to that of the small cavities 9.

As explained previously, the compression-molding of the LED chips (light-emitting elements) 4 can be performed with the tape 12 applied to the element-free surface 5a of the frame 5 with the LED chips 4 mounted thereon. This tape 12 efficiently prevents the resin from flowing from the element-mounted surface 5b to the element-free surface 5a of the frame 5 through the punch-out portions (through bores) and forming a burr (91), or efficiently prevents the resin from flowing from the element-mounted surface 5b to the element-free surface 5a of the frame 5 around the side edge of the frame 5 and forming a burr (91) on the frame 5, so that the yield of the product (light emitter) will be efficiently improved.

It is thus possible to efficiently improve the manufacturing efficiency of the product (light emitter 65).

The collective resin-molded light-emitting body 62 is a collection of light emitters 65 (light-emitting parts 64), which can function as a surface light source. It is also possible to cut the molded frame 61 at specific positions to obtain light emitters 65 (products).

Thus, according to the first embodiment, it is possible to provide a method of compression-molding light-emitting elements which can efficiently prevent the formation of a resin burr on the frame 5 on which light-emitting elements (e.g. LED chips) are mounted.

It is also possible according to the first embodiment to provide a method of compression-molding light-emitting elements which can efficiently improve the manufacturing efficiency of the product (light emitter 65).

It is additionally possible in the first embodiment to use a vacuum mechanism and a mold release film as will be described later (refer to the second embodiment for details).

### Second Embodiment

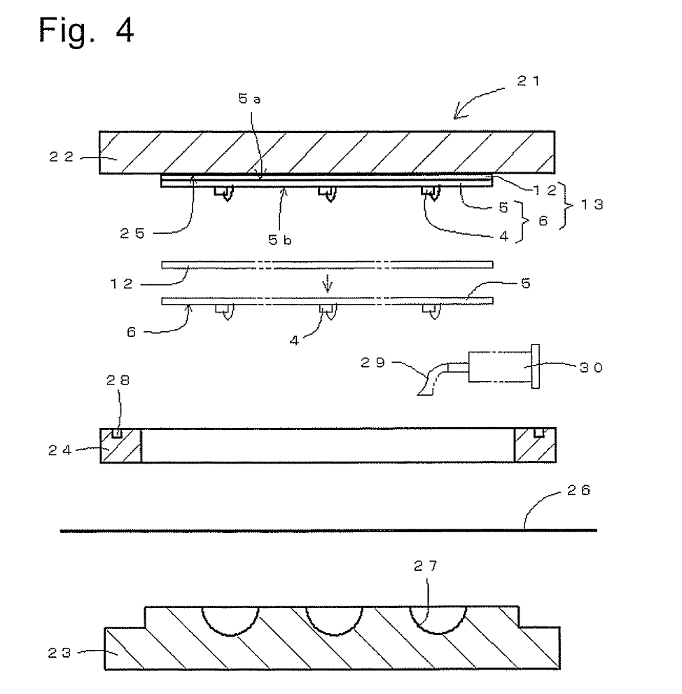

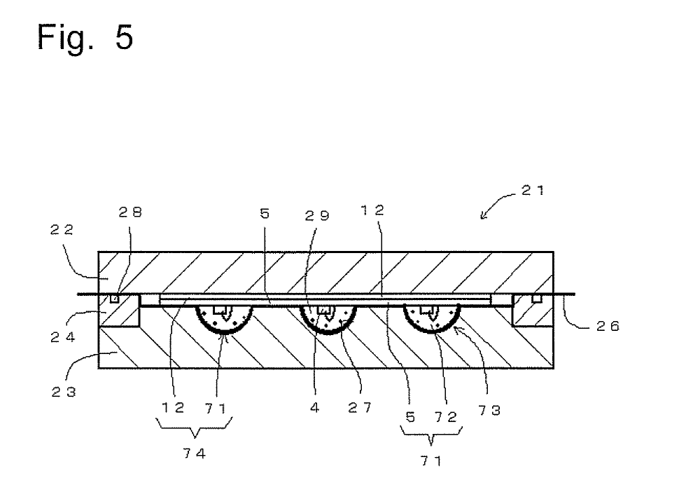

The second embodiment is hereinafter described using FIGS. 4 and 5.

The molding die for compression-molding light-emitting elements shown in FIGS. 4 and 5 is a three-piece type, including the upper, central and lower dies. However, its basic configuration is the same as that of the two-piece type molding die described in the first embodiment.

Using the molding die shown in FIGS. 4 and 5 in the compression-molding will result in a molded frame shown in FIG. 6(2).

As in the first embodiment, the method in the second embodiment uses an ante-molding frame with a required number of LED chips mounted thereon and a tape for resin burr prevention.

### (Details of Molded Frame)

The molded frame 71 shown in FIG. 6(2) consists of a frame 5 and a number of individual resin-molded light-emitting bodies (light-emitting parts) 72 with transparency (optical permeability).

Each of the light-emitting parts 72 is created by compression-molding (resin-encapsulating) an LED chip 4 mounted on the frame 5. The molded frame 71 (with a required number of LED chips 4) can function as a surface emission light source.

It is also possible to cut the molded frame 71 at specific positions to form a number of light emitters 73 (products), each including the light-emitting part 72 as the main component and a fragment of the ante-molding frame 6. Each light emitter 73 (or LED chip 4) can function as an independent light source.

### (Configuration of Molding Die for Compression-Molding Light-Emitting Elements)

The meal mold 21 for compression-molding light-emitting elements shown in FIGS. 4 and 5 includes a fixed upper die 22, a movable lower die 23 facing the upper die 22, and a central die (intermediate plate) 24 located between the upper die 22 and the lower die 23. The upper die 22 has a frame-setting section 25 formed in its molding surface. The molding die is also provided with a heating means (not shown) for heating the upper and lower dies 22 and 23 to a required temperature and a clamping means for clamping the upper and lower dies 22 and 23 by a required clamping pressure. A mold release film 26 is stretched between the central die 24 and the lower die 23.

The lower die 23 has individual cavities 27 formed in its molding surface. The number and positions of these cavities (which correspond to the small cavities in the first embodiment) correspond to those of the required number of LED chips 4 mounted on the frame 5 supplied and set on the setting section 25.

When the central die 24 and the lower die 23 are clamped together, the mold release film 26 will be sandwiched between the two dies 24 and 23, covering the molding surface of the lower die 23 and the inner surface of each cavity 27.

Within the molding die 21, an outside-air shut-off region (not shown) which at least includes the cavities 27 should be formed. For this purpose, an outside-air shut-off member 28 such as a seal member is provided at a specified position in the molding die 21, e.g. on the molding surface of the central die 24 facing the upper die. Also provided is a vacuum mechanism (not shown), such as a vacuum pump for forcefully removing air from the outside-air shut-off region formed in the molding die 21 to achieve a specified degree of vacuum within the outside-air shut-off region.

Therefore, when the molding die 21 (22, 23 and 24) is closed, the outside-air shut-off region at least including the cavities 27 can be set at a specified degree of vacuum.

Also provided for the molding die 21 is a horizontal dispenser 30 for supplying a required amount of transparent liquid resin material 29 into each of the individual cavities 27. (This dispenser is drawn in double-dashed chain lines in FIG. 4).

When the central die 24 and the lower die 23 are clamped together, a required amount of transparent liquid resin material 29 can be supplied by the horizontal dispenser 30 into each of the individual cavities 27 covered with the mold release film 26.

It should be noted that the individual cavities 27 are isolated from each other.

### (Method of Compression-Molding Light-Emitting Elements)

Firstly, a resin burr prevention tape 12 is applied to the element-free surface 5a of the frame 5 (ante-molding frame 6), on which the LED chips 4 are mounted, to form a tape-applied frame 13. The tape-applied frame 13 is then supplied and set onto the setting section 25 of the upper die, after which the central die 24 and the lower die 23 are clamped together to hold the mold release film 26 in between, making the mold release film 26 cover the inner surface of the individual cavities 27.

Next, a required amount of transparent liquid resin material 29 is supplied from the horizontal dispenser 30 into each of the individual cavities 27 covered with the mold release film 26, after which the molding die 21 (22, 23 and 24) is closed.

In this process, the LED chips 4 are individually immersed into the resin 29 contained in the cavities 27 of the lower die 23. Simultaneously, the clamping pressure applies a required resin pressure to the inside of each cavity 27.

After a period of time required for the resin to harden has elapsed, the molding die 1 is opened to obtain the LED chips 4 that are each compression-molded in an individual resin-molded light-emitting body 72 with transparency whose shape corresponds to that of the individual cavity 27.

After the compression-molding is completed, the tape 12 is peeled off from the tape-applied frame 74 to obtain the molded frame 71.

As explained previously, the compression-molding of the LED chips (light-emitting elements) 4 in the second embodiment can be performed with the tape 12 applied to the element-free surface 5a of the frame 5 with the LED chips 4 mounted thereon. As in the first embodiment, this tape 12 efficiently prevents the resin from flowing from the element-mounted surface 5b to the element-free surface 5a of the frame 5 through the punch-out portions (through bores) of the frame 5 and forming a burr, or efficiently prevents the resin from flowing from the element-mounted surface 5b to the element-free surface 5a of the frame 5 around the side edge of the frame 5 and forming a burr (91) on the frame 5, so that the yield of the product (light emitter) will be efficiently improved.

It is thus possible to efficiently improve the manufacturing efficiency of the product (light emitter 73) in the second embodiment.

The individual resin-molded light-emitting bodies 72 (light emitters 73) collectively function as a surface light source. It is also possible to cut the molded frame 71 in the second embodiment at specific positions to obtain light emitters 73 (products) each of which can function as an independent light source.

Thus, according to the second embodiment, it is possible to provide a method of compression-molding light-emitting elements which can efficiently prevent the formation of a resin burr on the frame 5 on which light-emitting elements (e.g. LED chips) are mounted.

It is also possible according to the second embodiment to provide a method of compression-molding light-emitting elements which can efficiently improve the manufacturing efficiency of the product (light emitter 73).

The present invention is not limited to the previously described embodiments; the configurations in those embodiments may be arbitrarily and appropriately modified or selected as needed without departing from the spirit of the present invention.

In the previous embodiments, the resin burr prevention tape 12 was applied to the entire element-free surface 5a of the frame 5. Alternatively, the resin burr prevention tape 12 may be applied to specific portions of the element-free surface 5a of the frame 5.

It is also possible in the previous embodiments to simultaneously perform both the supplying of the ante-molding tape-applied frame 13 and the supplying of the resin material 10 or 29 by the dispenser.

In the previous embodiments, the resin-molded light-emitting body 62 or 72 (light emitter 65 or 73) having a required shape was assumed to be a convex lens, as shown in the illustrated examples. However, the resin-molded light-emitting body 62 or 72 (light emitter 65 or 73) may have various shapes, such as a concave lens or Fresnel lens.

The resin material used in the previous embodiments was a thermosetting resin, which may be replaced by a thermoplastic resin.

The resin material used in the previous embodiments was a liquid resin, which may be replaced by various forms of resin materials, such as a powdered resin or granular resin.

In the case of using a powdered resin, granular resin or similar type of resin, it is naturally necessary to heat the resin material into a molten state inside the cavities.

Examples of the resin material used in the previous embodiments include silicon resins and epoxy resins.

The resin material used in the previous embodiments was assumed to be a transparent resin, which may be replaced by various kinds of resin materials, such as a translucent resin or a resin containing a phosphorescent or fluorescent material.

### Third Embodiment

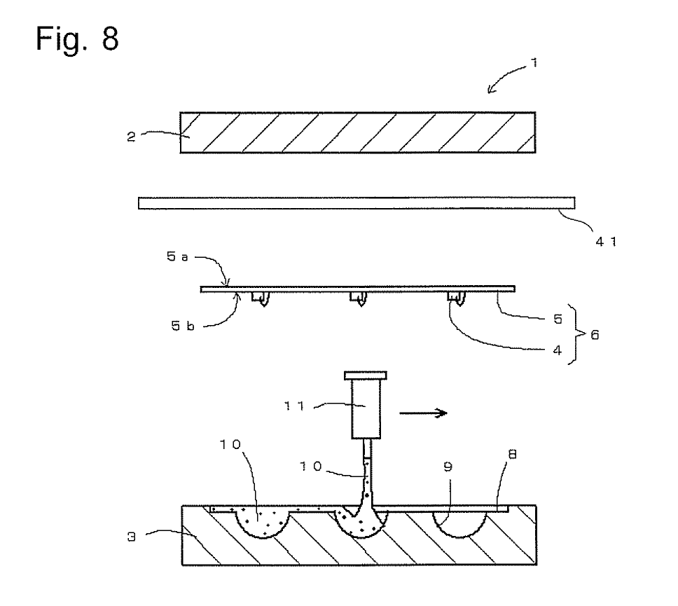

A vertical sectional view of a compression-molding molding die as the third embodiment is shown in FIG. 8. This mold uses a release film 41 in place of the tape. Such a film has been generally used for mold-releasing purposes.

In the molding process, the upper and lower dies are opened, and then the release film 41 is inserted between the frame 5 and the fixed upper die 2. There are several methods for inserting the release film 41: placing the film on the upper surface of the frame 5, fixing the film to the lower surface of the fixed upper die 2, or sandwiching the film between the frame 5 and the upper die 2. For fixing the film to the lower surface of the fixed upper die 2, one method is to create vacuum holes in the lower surface of the upper die and draw air through these holes to hold the release film 41 by suction; another method is to bond the film with a weak adhesive. For holding the film between the frame 5 and the fixed upper die 2, one method is to make the release film 41 large enough to be stretched over the edge of the molding surface of the molding die and have its edge held with a fastener outside the molding die; another method is to prepare the release film 41 in a belt-like form and feed it into the space between the frame 5 and the fixed upper die 2 by a roll-to-roll process.

After the release film 41 is set at a predetermined position, the molding die is closed. Then, the fixed upper die 2 presses the resin-made release film 41, making it tightly adhered to the upper surface of the frame 5. The adhered film leaves no space for the liquid resin material 10 to penetrate above the upper surface of the frame 5, so that a resin burr cannot be formed.

1. A method of compression-molding light-emitting elements, using a molding die for compression-molding light-emitting elements, the molding die including at least upper and lower dies, characterized by the following processes: supplying and setting a frame, with a required number of light-emitting elements mounted thereon, onto a frame-setting section provided in the upper die of the molding die; supplying a required amount of resin material into each of individual cavities formed in the lower die of the molding die, the individual cavities respectively corresponding to the required number of light-emitting elements mounted on the frame; and compression-molding a light emitter within each individual cavity by clamping the dies of the molding die in such a manner that the light-emitting elements are respectively immersed into the resin contained in the individual cavities,
wherein the compression-molding process is performed with a resin sheet for resin burr prevention sandwiched between the upper die and a surface of the frame on which no light-emitting element is mounted.

2. The method of compression-molding light-emitting elements according to claim 1, further characterized by: creating a molded frame by performing the compression-molding process with the resin sheet for resin burr prevention sandwiched between the upper die and the surface of the frame on which no light-emitting element is mounted; and cutting the molded frame at a specific position to form an individual light emitter.

3. The method of compression-molding light-emitting elements according to claim 1, wherein the resin supplied into the individual cavities is uniformly distributed through a connection channel interconnecting the individual cavities.

4. The method of compression-molding light-emitting elements according to claim 1, wherein the compression-molding process is performed with a mold release film covering an inside of the individual cavities.

5. The method of compression-molding light-emitting elements according to claim 1, wherein the compression-molding of the light-emitting elements being immersed in the individual cavities is performed while an outside-air shut-off region, which includes at least an inside of the individual cavities, is maintained at a predetermined degree of vacuum.

6. The method of compression-molding light-emitting elements according to claim 1, wherein the resin sheet is a tape applied on the surface on which no light-emitting element is mounted.

7. The method of compression-molding light-emitting elements according to claim 1, wherein the resin sheet is a release film.

8. The method of compression-molding light-emitting elements according to claim 2, wherein the resin sheet is a tape applied on the surface on which no light-emitting element is mounted.

9. The method of compression-molding light-emitting elements according to claim 3, wherein the resin sheet is a tape applied on the surface on which no light-emitting element is mounted.

10. The method of compression-molding light-emitting elements according to claim 4, wherein the resin sheet is a tape applied on the surface on which no light-emitting element is mounted.

11. The method of compression-molding light-emitting elements according to claim 5, wherein the resin sheet is a tape applied on the surface on which no light-emitting element is mounted.

12. The method of compression-molding light-emitting elements according to claim 2, wherein the resin sheet is a release film.

13. The method of compression-molding light-emitting elements according to claim 3, wherein the resin sheet is a release film.

14. The method of compression-molding light-emitting elements according to claim 4, wherein the resin sheet is a release film.

15. The method of compression-molding light-emitting elements according to claim 5, wherein the resin sheet is a release film.
